(19) United States
(12) Patent Application Publication
(10) Pub. No.: US 2007/0102993 A1
(43) Pub. Date: May 10, 2007

(54) Rotatable hubcap assembly with audio generating device

(76) Inventor: Alan M. Kagen, Pooler, GA (US)

Correspondence Address: NIXON & VANDERHYE, PC, 901 NORTH GLEBE ROAD, 11TH FLOOR, ARLINGTON, VA, 22203, US

(21) Appl. No.: 11/594,873

(22) Filed: Nov. 9, 2006

Related U.S. Application Data
(60) Provisional application No. 60/734,769, filed on Nov. 9, 2005.

(51) Int. Cl. B60B 7/04

(52) U.S. Cl. 301/37.25

(57) ABSTRACT

A spinning hubcap assembly includes a stationary member attachable to a vehicle wheel and fixed relative to the vehicle wheel, and a rotatable member attached to the stationary member, where the rotatable member is rotatable relative to the stationary member. An audible sound generator is operably coupled between the stationary member and the rotatable member, which audible sound generator is triggered based on rotation of the rotatable member relative to the stationary member. Preferably, the audible sound generator makes a sound resembling a barking dog.

### CROSS-REFERENCES TO RELATED APPLICATIONS

This application claims the benefit of U.S. Provisional Patent Application Ser. No. 60/734,769, filed Nov. 9, 2005, the entire content of which is herein incorporated by reference.

### STATEMENT REGARDING FEDERALLY SPONSORED RESEARCH OR DEVELOPMENT

### Not Applicable

### BACKGROUND OF THE INVENTION

The present invention relates to hubcaps, in particular to a hubcap assembly that permits a hubcap to spin independently from an associated vehicular wheel while emitting an audible sound, such as the sound of a dog bark.

There have been several inventions relating to rotating hubcaps and wheel covers. Many of these references, for example, U.S. Pat. No. 5,490,342 to Rutterman et al., U.S. Pat. No. 5,588,715 to Harlen, and U.S. Pat. No. 5,659,989 to Hsiao et al. disclose different mechanisms that allow a hubcap to maintain its rotational orientation independent of the rotation of the associated wheel. Each of these inventions employs some type of weighting mechanism to maintain the hubcap's orientation regardless of the reverse or forward rotation of the associated wheel. These inventions differ from the present invention in that the present invention employs no weighting mechanism, and permits the hubcap to rotate independently from its associated wheel, preferably in only one direction of rotation.

U.S. Pat. No. 3,158,946 discloses a spinning hub cap designed to be spun relative to the vehicle wheel on which it is mounted, as the vehicle wheel rolls forward, and to continue to spin after the vehicle wheel has been brought to a stop. U.S. Pat. No. 6,655,061 uses a bearing clutch rather than a ratchet type mechanism to control hubcap rotation.

All of the patents mentioned above are hereby incorporated by reference.

### BRIEF SUMMARY OF THE INVENTION

In an exemplary embodiment of the invention, a spinning hubcap assembly includes a stationary member attachable to a vehicle wheel and fixed relative to the vehicle wheel, and a rotatable member attached to the stationary member, where the rotatable member is rotatable relative to the stationary member. An audible sound generator is operably coupled between the stationary member and the rotatable member, which audible sound generator is triggered based on rotation of the rotatable member relative to the stationary member.

The audible sound generator is preferably triggered cyclically based on rotation of the rotatable member relative to the stationary member.

The audible sound generator may include first and second friction members attached respectively to the stationary member and the rotatable member, where the first and second friction members emit a sound as the second friction member is cyclically brought into contact with the first friction member by rotation of the rotatable member. Alternatively, the audible sound generator may include an electronic output and a sensor secured to the rotatable member, the sensor activating the electronic output upon each full rotation of the rotatable member. In a preferred arrangement, the audible sound generator makes a sound resembling a dog bark.

### BRIEF DESCRIPTION OF THE DRAWINGS

These and other aspects and advantages of the present invention will be described in detail with reference to the accompanying drawings, in which:

FIG. 1 is an exemplary configuration of a free spinning hubcap assembly; and

FIG. 2 illustrates a sectional view of the hubcap assembly in FIG. 1.

### DETAILED DESCRIPTION OF THE INVENTION

The invention is suitable for use with any hubcap or wheel assembly where one part moves relative to another based on vehicle motion. The assembly will be described in conjunction with an exemplary construction from the above-noted U.S. Pat. No. 6,655,061.

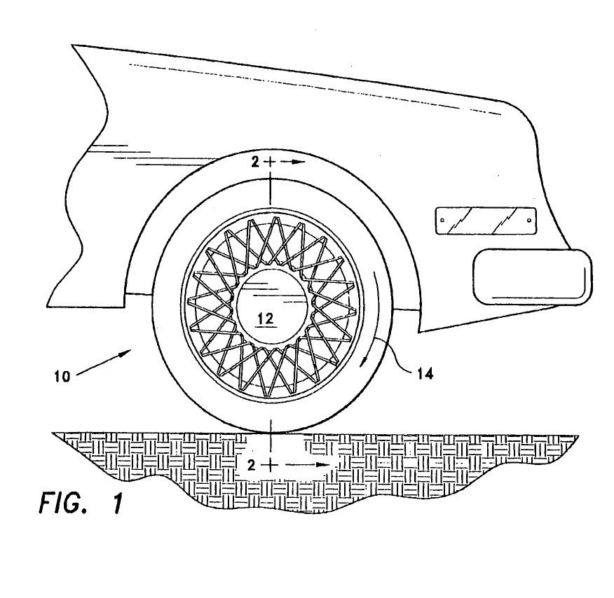

The exemplary configuration, as shown in FIG. 1, is a one way free spinning hubcap assembly, designated generally as 10 in the drawings. The assembly 10 has a decorative hubcap 12 that is positioned adjacent a vehicular wheel. The internal mechanisms of the invention, discussed below, cause the hubcap to rotate with the wheel when the wheel is turning in the direction of arrow 14. Therefore, when a vehicle employing the present invention is accelerating forward or maintaining its forward velocity, the hubcap rotates at the same speed as the associated wheel, as would a conventional hubcap; however, when the vehicle decelerates, a bearing clutch in the assembly 10 permits the hubcap to continue to freely rotate, giving the appearance that the entire wheel is quickly rotating even when the wheel itself is slowing or has stopped rotating.

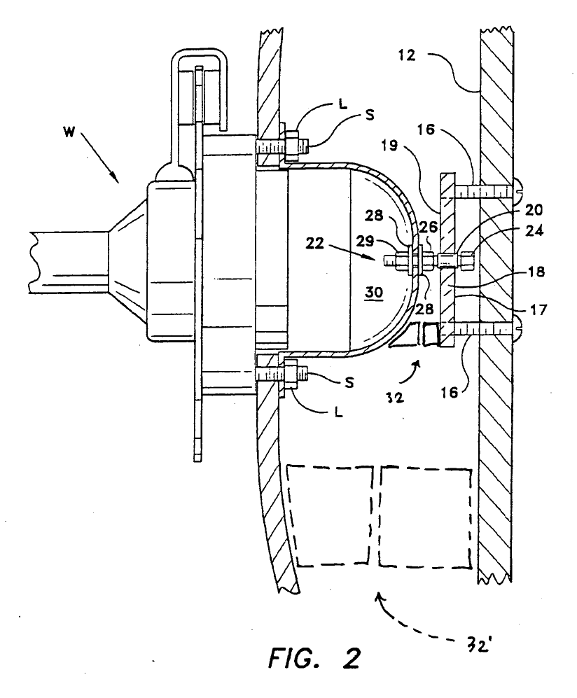

FIG. 2 illustrates a sectional view of the hubcap assembly in FIG. 1. The assembly 10 has a hubcap 12 which is connected by several hubcap bolts 16 to a bolt collar 18. The bolt collar 18 is a flat plate with an outer surface 17 and an inner surface 19. Disposed in the center of the collar 18 and extending just past the outer 17 and inner 19 surfaces is a bearing clutch 20.

The assembly 10 further includes a central bolt 22 having a head 24 and a shank. The central bolt 22 extends through the bearing clutch 20 and the associated bolt collar 18. Next, the central bolt 22 extends through an outer nut 26 and a lock washer 28, then through a dome shaped hub bracket 30. The central bolt 22 finally extends through a second lock washer 28 and is secured by inner nut 29. The hub bracket 30 itself is secured to a vehicle's wheel assembly W through the use of the vehicle's wheel studs S and lug nuts L.

An audible sound generator 32 is operably coupled between relatively movable parts such as between the bolt collar 18 and the hub bracket 30, or alternatively between the hubcap 12 and the wheel assembly W (shown as 32′ in dashed line in FIG. 2). The audible sound generator is triggered based on relative rotation of parts to which the sound generator 32 (32′) components are attached. In a preferred embodiment, the audible sound generator makes a sound resembling a dog bark. In this context, movement of the vehicle rotates the hubcap, which continues to spin after the vehicle wheel has been brought to a stop. In a preferred arrangement, the audible sound generator 32 (32′) is triggered cyclically based on rotation of the hubcap 12. Thus, with audible sound generators installed on all four wheels of a vehicle, as the vehicle comes to a stop, the audible sound generators emulate the sound of a pack of dogs.

Any suitable audible sound generator may be used, and the invention is not necessarily meant to be limited to any one type. One suitable sound generator utilizes first and second friction members attached respectively to the relatively movable parts, where the first and second friction members emit a sound as the second friction member is cyclically brought into contact with the first friction member by rotation of the hubcap. Alternatively, the audible sound generator may include an electronic output and a sensor secured to the hubcap, the sensor activating the electronic output upon each full rotation of the hubcap.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

1. A spinning hubcap assembly comprising:
a stationary member attachable to a vehicle wheel and fixed relative to the vehicle wheel;
a rotatable member attached to the stationary member, the rotatable member being rotatable relative to the stationary member; and
an audible sound generator operably coupled between the stationary member and the rotatable member, the audible sound generator being triggered based on rotation of the rotatable member relative to the stationary member.

2. A spinning hubcap and wheel assembly according to claim 1, wherein the audible sound generator comprises first and second friction members attached respectively to the stationary member and the rotatable member, the first and second friction members emitting a sound as the second friction member is cyclically brought into contact with the first friction member by rotation of the rotatable member.

3. A spinning hubcap and wheel assembly according to claim 1, wherein the audible sound generator comprises an electronic output and a sensor secured to the rotatable member, the sensor activating the electronic output upon each full rotation of the rotatable member.

4. A spinning hubcap and wheel assembly according to claim 1, wherein the audible sound generator makes a sound resembling a dog bark.

5. A spinning hubcap and wheel assembly according to claim 1, wherein the audible sound generator is triggered cyclically based on rotation of the rotatable member relative to the stationary member.
